(19) United States
(12) Patent Application Publication
(10) Pub. No.: US 2016/0072741 A1
(43) Pub. Date: Mar. 10, 2016

(54) METADATA BASED USER DEVICE COMMUNICATIONS

(71) Applicant: Accenture Global Solutions Limited, Dublin (IE)

(72) Inventors: Mary HAMILTON, Chicago, IL (US); Beata KORYTKOWSKI, Chicago, IL (US); Joshua KAHN, Chicago, IL (US); Charles NEBOLSKY, Northbrook, IL (US)

(21) Appl. No.: 14/941,394

(22) Filed: Nov. 13, 2015

Related U.S. Application Data
(63) Continuation-in-part of application No. 11/686,736, filed on Mar. 15, 2007.

(51) Int. Cl. H04L 12/58; H04L 29/08

(52) U.S. Cl. CPC H04L 51/04; H04L 67/306

(57) ABSTRACT

A system includes a user device and a controller device. The user device is configured to receive messages via user interface components associated with a user interface, analyze, based on receiving the messages, the messages, generate metadata values based on analyzing the messages, and provide the messages and the metadata values to the controller device, via the user interface. The controller device is configured to receive the messages and the metadata values from the user device, via the user interface, receive profile information associated with the user device from a database server device, identify recipient user devices for the messages based on the metadata values and based on the profile information, and cause the messages to be provided to the recipient user devices.

### RELATED APPLICATIONS

This application is a continuation-in-part of U.S. patent application Ser. No. 11/686,736, filed on Mar. 15, 2007, the entire contents of which are hereby incorporated by reference.

### BACKGROUND

With the advent of more powerful communication technologies, the use of cross-border collaborative project teams has increased. For example, it is not uncommon in the software development industry to have teams of developers and management spread across the globe. While such collaborative project teams typically enjoy the benefit of being able to draw upon efficient resources, the remoteness between team members can give rise to significant challenges that may significantly undercut, or entirely overwhelm, the efficiencies gained.

For example, where the project at hand comprises complex work involving a significant need for interaction between team members, remote collaborators that are not co-located with project management often have a difficult time establishing contextual knowledge relevant to the project. For example, on a software development project, a developer in India may not fully appreciate the project requirements worked out through face-to-face meetings with the customer by U.S.-based project managers. On the other hand, a project manager may not be able to quickly appreciate the subtleties of a technological issue encountered by the development team without significantly interacting with the developers. Such inefficiencies can be compounded by the fact that different team members may have different levels of experience and knowledge, thereby making it difficult to maintain quality. Additionally, differences in time zones between team members may create substantial lags in response time when critical issues arise, and provide a limited amount of time in which multiple team members may conference together. Further still, differences in culture or language may create difficulties when trying to understand implied instructions from team management. A particular result of these collaborative hurdles is, often, an inability of project management to quickly ascertain the status or progress of work being performed by remote team members.

Prior art solutions to such collaboration difficulties tend to be ad hoc approaches using existing, disparate content repositories and communication and tracking tools. For example, project team members may attempt to use emails as the primary channel for communicating issues as they arise or to use issue tracking software to maintain historical context regarding how such issues were addressed. While such tools are individually suited for the particular tasks for which they are designed, collectively, they typically are unable to provide the necessary level of structure and support to maximize efficiency of the collaboration team. Further, existing tools that may contain workflow functionality to formalize and structure standard types of communication, e.g., issue tracking, risk management, document versioning, do not account for informal communications that are necessary to perform collaborative work. Stated another way, there currently are no systems or tools that provide coordinated operation between such separate collaboration tools. A consequence of this shortcoming is a lack of context. As used herein ‘context’ comprises any information that provides greater understanding of the subject matter of a given communication or deliverable artifact, such as a document or portion of code, beyond the actual content of the item, e.g., historical information concerning a specific issue, identification of specific parties having an interest in the specific subject matter, classification of the subject matter, etc. Such context in communications between team members typically ensures more meaningful communications, e.g., the difference between awareness of the content of a communication and a true understanding of the implications of such content. Therefore, a collaboration system or suite of tools that overcome these problems would represent an advancement in the art.

### SUMMARY OF THE INVENTION

The present invention overcomes the limitations of the prior art described above through the use of a system that includes a user device and a controller device. The user device may receive messages via user interface components associated with a user interface, and may analyze, based on receiving the messages, the messages. The user device may generate metadata values based on analyzing the messages, and may provide the messages and the metadata values to the controller device, via the user interface. The controller device may receive the messages and the metadata values from the user device, via the user interface, and may receive profile information associated with the user device from a database server device. The controller device may identify recipient user devices for the messages based on the metadata values and based on the profile information, and may cause the messages to be provided to the recipient user devices.

The present invention overcomes the limitations of the prior art described above through the use of an integrated collaboration system. The collaboration system in accordance with the present invention draws upon three guiding principles in its structure and operation. First, it is necessary to organize communication channels between collaboration team members. Second, it is necessary to build context around communications between team members. Third, wherever possible, relationships between collaborators should be enhanced. To this end, the collaboration system of the present invention provides various components that allow currently-used communication channels, e.g., electronic mail, instant messaging, etc., and content formats, e.g., text, audio, images, video, etc., to be organized such that contextual information surrounding messages sent within the system is more readily captured and used to organize the messages.

Thus, in one aspect of the inventive collaboration system, a processing device (e.g., a user terminal) used to support communications between users of the collaboration system is operative to capture (preferably, automatically) occurrence of at least one event-defined in accordance with a project plan-caused by a user of the processing device. That is, the project plan, among other things, defines one or more events of significance to the project being worked upon by a collaborative team and that may be automatically captured. For example, in the context of a software development project, such events may include checking in/out a given code module from a code library, or releasing a given set of code for use in production.

Information regarding each such captured event is stored and an activity report based at least in part upon the stored event information is provided by the processing device (preferably via a controller) to at least one other user of the collaboration system. The user may cause report annotations (which may comprise text, audio, images, video or any other combination of human-perceivable information) to be associated with the activity report. A controller within the collaboration system is employed to route the activity report (and any associated annotations) to other users of the collaboration system. The recipients of the activity report may submit their own annotations to the controller for association with the activity report. Furthermore, the controller may operate to aggregate the activity report with other activity reports of other users of the collaboration system, which other activity reports may likewise comprise associated amlotations. The resulting aggregated activity report may be provided to one or more collaboration system users just like any other activity report. In one embodiment of the present invention, the targeted recipient(s) of an activity report (whether aggregated or otherwise) may be designated on an opt-in, subscription basis. Regardless, activity reports automatically generated in this manner may be used by collaboration team members to quickly ascertain the status and/or progress of work being performed by other team members despite great differences in locations, time zones, language, culture, etc.

### BRIEF DESCRIPTION OF THE DRAWINGS

The features of the present invention are set forth with particularity in the appended claims. The invention itself, together with further features and attended advantages, will become apparent from consideration of the following detailed description, taken in conjunction with the accompanying drawings. One or more embodiments of the present invention are now described, by way of example only, with reference to the accompanied drawings wherein like reference numerals represent like elements and in which:

FIG. 1A is a diagram of an overview of an example implementation described herein;

FIG. 1B is a functional illustration of a collaboration system in accordance with an embodiment of the present invention;

FIG. 2 is a schematic block diagram of a communication system in accordance with an embodiment of the present invention;

FIG. 3 is a functional block diagram of a collaboration system in accordance with an embodiment of the present invention;

FIG. 4 is a flow chart illustrating operation of a user terminal in accordance with an embodiment of the present invention;

FIG. 5 is a flow chart illustrating operation of a controller m accordance with an embodiment of the present invention;

FIG. 6 is a flow chart illustrating a distribution process m accordance with an embodiment of the present invention;

FIGS. 7 and 8 illustrate various features of a user interface in accordance with an embodiment of the present invention;

FIG. 9 is an illustration of an email interface in accordance with an embodiment of the present invention;

FIG. 10 is an illustration of an email input interface in accordance with an embodiment of the present invention;

FIG. 11 is an illustration of a media capture input interface in accordance with an embodiment of the present invention;

FIG. 12 is a flow chart illustrating operation of a user terminal in accordance with another embodiment of the present invention; and

FIG. 13 is a flow chart illustrating operation of a controller in accordance with another embodiment of the present invention.

### DETAILED DESCRIPTION OF THE PRESENT EMBODIMENTS

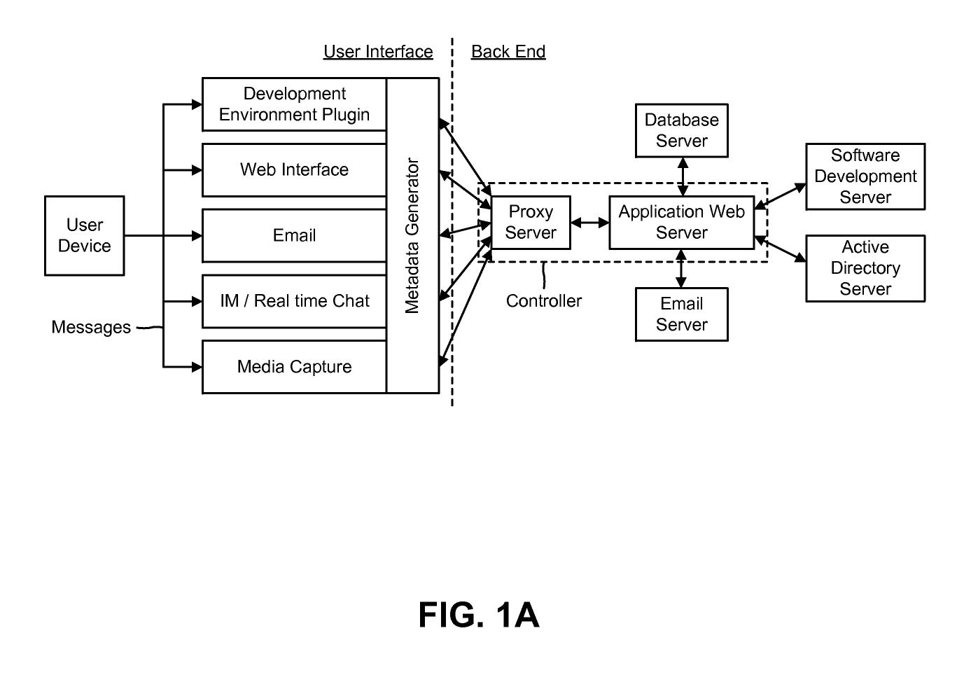

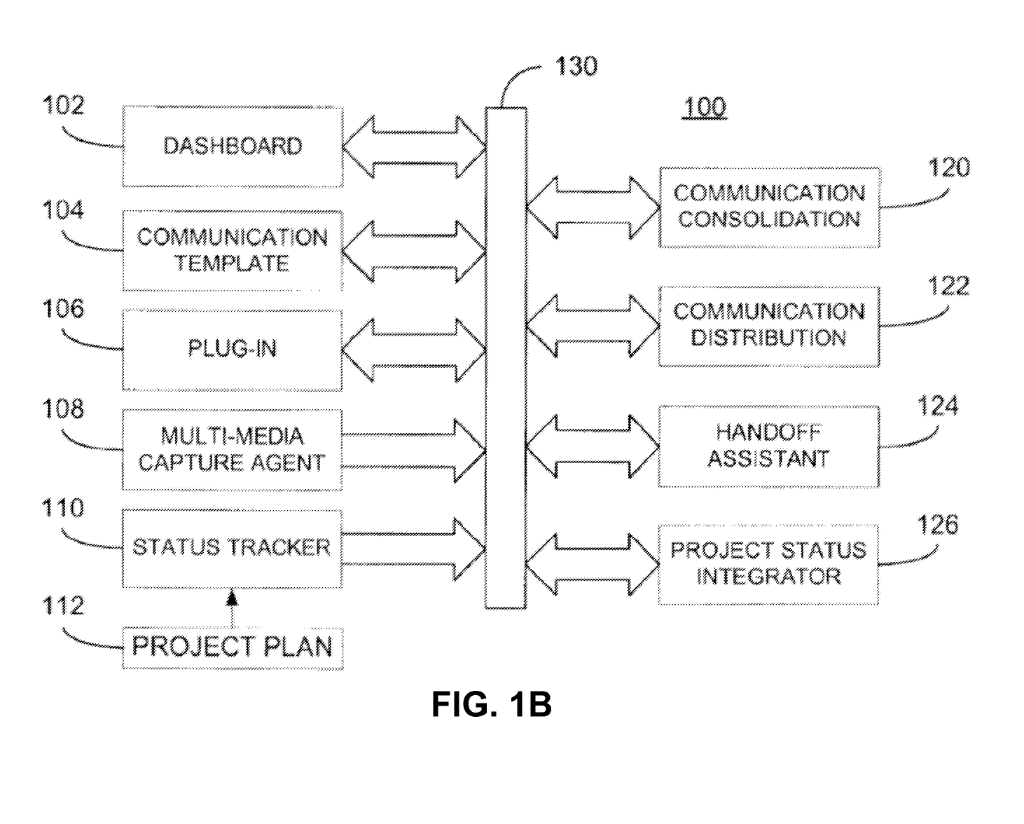

FIG. 1A is a diagram of an overview of an example implementation described herein. As shown in FIG. 1A, a user device may provide messages to a controller, via a user interface. The user device may include a processor-based device, such as a computer (or other device) that includes one or more processors in communication with at least one storage component. The controller may include a processor-based device that includes at least one processor and at least one storage component. The controller may include a proxy server and an application web server, and may be associated with a back end system that includes a database server, an email server, a software development server, and an active directory server.

As further shown in FIG. 1A, the user interface may include a development environment plug-in, a web interface, an email toolbar and interface, an instant messaging (IM) or chat interface, and a stand-alone media capture interface, each operating in conjunction with a metadata generator. The development environment plug-in may include a plug-in suitable for communicating and operating with a software development program. In general, the plug-in may implement substantially similar functionality as the web interface, the email toolbar interface, the IM interface, and any other interface that provides the ability to generate messages, as described below. The web interface may implement the functions of a dashboard, described in greater detail below. Similarly, the email interface and/or the IM/chat interface may implement the functions of a communication template, also described in greater detail below. The stand-alone media capture interface may implement the functions of a multi-media capture agent, described in greater detail below.

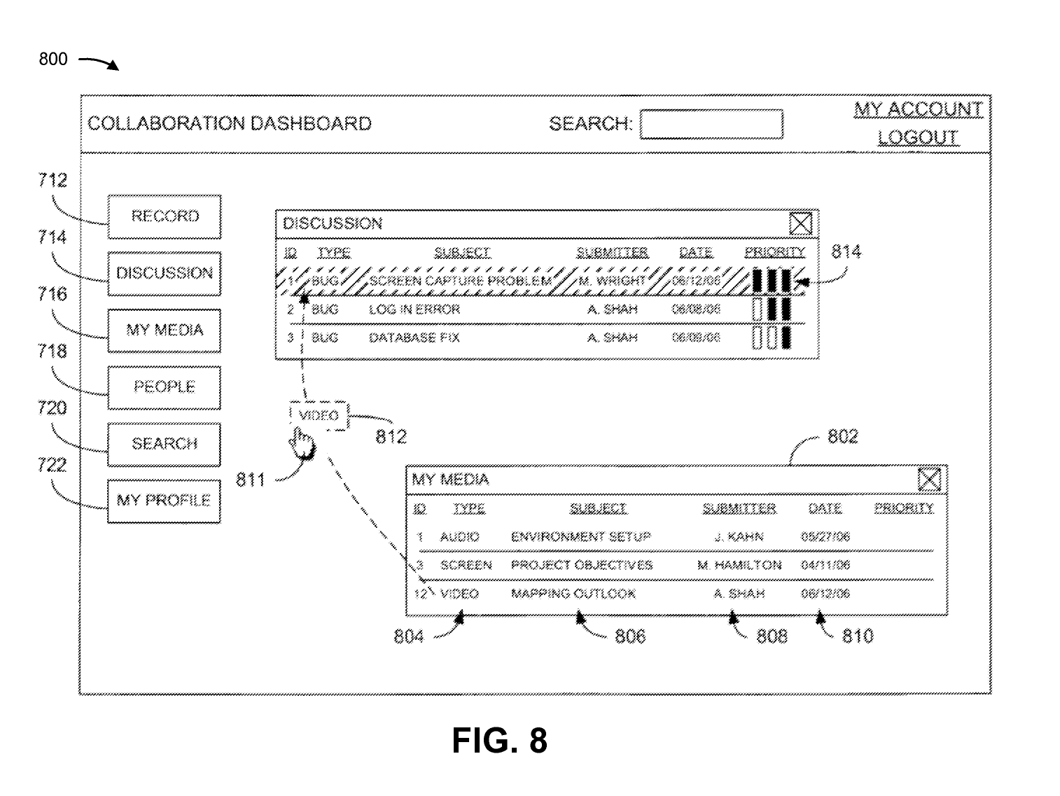

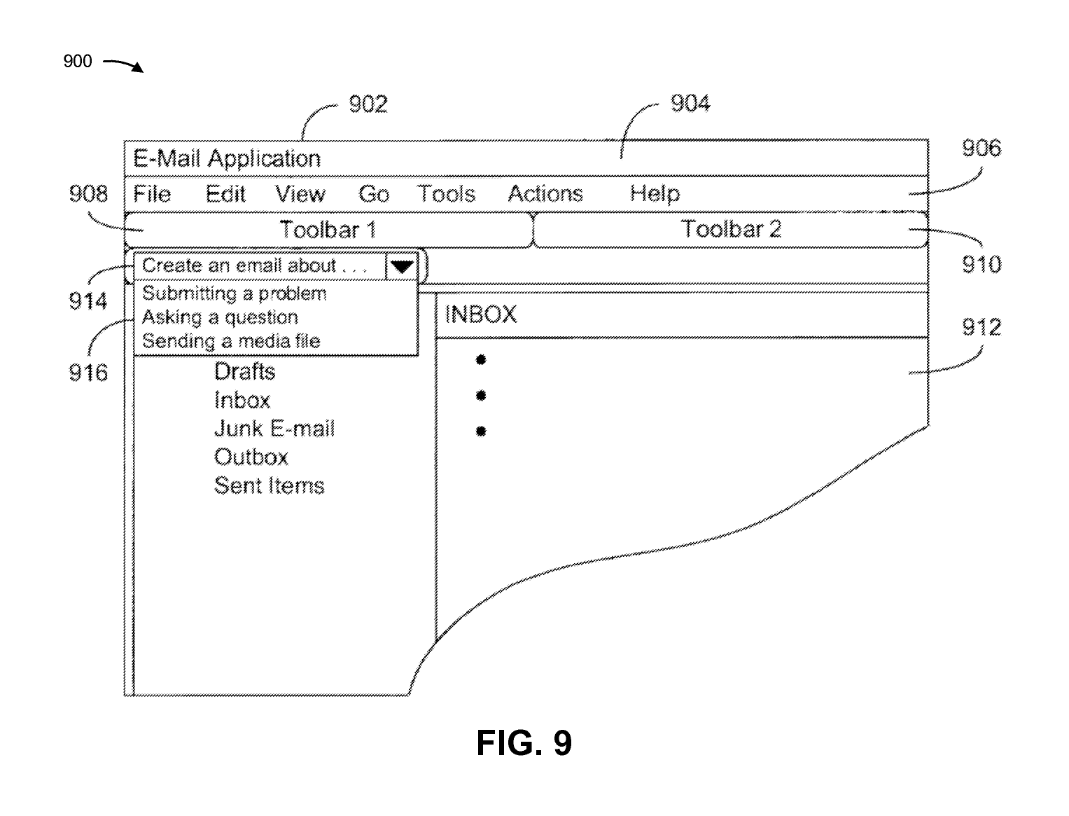

The metadata generator may operate in conjunction with the various user interface components to generate metadata values, in accordance with standardized metadata attributes, and based on the messages. For example, the metadata generator may receive user selections corresponding to predefined metadata input values, or may receive data entered via a user-definable metadata value input field, as described below in connection with FIGS. 8 and 9. Additionally, the metadata generator may populate predefined metadata input fields based on variables, such as date, time, user identification, communication type, etc. The metadata generator may automatically generate metadata based on analyses of the messages created via the various interfaces. For example, for communications employing a text format, individual communications can be scanned by the metadata generator, using text parsing techniques, to identify key words that may be used as the metadata. Although the metadata generator is illustrated as a single component in FIG. 1A, in some implementations, a metadata generator may be provided for each of the various user interface components. The metadata generator may provide metadata values for each communication (message) provided to the back end system. Through such metadata attributes and values, the metadata generator may create associations between disparate communication channels, thereby creating valuable context to such communications.

As shown in FIG. 1A, the servers of the back end system may be arranged in a network configuration, and may communicate with each other and/or with user devices. The proxy server may be an interface to the back end system. In some implementations, the proxy server may provide users of the back end system with access to the services and resources made available by the other back end servers. As shown, the proxy server may communicate with the application web server. In some implementations, the combination of the proxy server and the application web server may perform the functions of the controller, described herein. The application web server may communicate with the database server. The database server may store one or more project profiles, user profiles, communication preferences, identifications of work groups and related/subscribed users, message content, metadata for messages and content files, pointers to content files, linking information between messages, and/or the like. The email server may support communications between user devices using an email communication program. In some implementations, the email communications originating from a given user device (and a corresponding user interface) may be first processed by the proxy server and the web application server, as described herein. Thereafter, the email server may provide such communications to intended recipients.

The active directory server may communicate with the application web server, and may permit one or more system administrators to control configuration and/or operation of the various components within the back end system and/or the user devices. The software development server may communicate with the application web server, and may implement a suitable workflow automation tool. In some implementations, other server devices, executing applications appropriate for use on different types of collaborative projects, may be provided in the back end system.

Referring now to FIG. 1B, a collaboration system 100 in accordance with the present invention is functionally illustrated. The collaboration system 100 is essentially a communication system that is enhanced with features that provide greater support to collaborative teams than currently available. In particular, the system 100 comprises one or more user interface components 102-110 and one or more back-end components 120-126 communicating with each other via at least one communication channel 130. In a presently preferred embodiment, each of the interface components 102-110 and each of the back-end components 120-126 are implemented using known software programming techniques. Using such techniques, suitable processing devices (such as desktop/laptop/handheld computers, mobile communication devices such as cellular phones, personal digital assistants, one or more server computers, etc.) may operate under the control of executable instructions to carry out the various functions described herein. However, those having skill in the art will appreciate that various other techniques may be equally employed, in whole or in part, to implement the operations of the present invention including, but not limited to, application specific integrated circuits (ASICs), programmable logic arrays implementing state machines, etc.

Generally, the interface components 102-110 serve as a mechanism for a user of the system 100 to generate communications or activity reports for distribution to other users of the system 100 while providing greater ability to generate, preserve and use contextual information that fosters greater understanding among collaborators. For example, the interface components may include a dashboard 102 that serves as a central portal for accessing the various features of the collaboration system. In a presently preferred embodiment, the dashboard 102 is implemented as a web-based, graphical interface, using techniques known to those having skill in the art. Using the dashboard 102, a user of the system may access, create, and manage any communications that he/she generates or receives, control a profile of the user maintained by the system, access such profiles of other collaborators and access and manage various content or media files generated/received by the user.

A communication template 104 serves as a standardized interface for the generation of one or more types of communications and corresponding metadata. Preferably, the communication template I 04 is based on one or more existing, software-based communication applications, such as Microsoft's “OUTLOOK” email application. As described in greater detail below, the metadata captured in this manner is preferably based on a plurality of standardized metadata attributes that are defined in accordance with the particular needs of the collaborative project. For example, a software development team may have one set of metadata attributes that would be most useful, whereas an industrial manufacturing team may have another set of metadata attributes that would be most useful. The one or more communication types supported by the communication template 104 may be any commonly used types such as email, instant messaging, short message service (SMS), etc. To support such different services, the communication template 104 may comprise multiple templates, one for each communication type, but each still implementing the standardized metadata attributes. Techniques for implementing one or more templates of this type are well known to those having ordinary skill in the art. Such multiple templates, if used, could be provided with a common user interface or maintained as separately usable entities. Regardless, the standardized nature of the templates ensures that users are triggered to provide the most important relevant information for each type of communication.

Recognizing that the most convenient point for generating certain communications may be within particular tools used by the various collaborators, the present invention also provides for the integration of communication interfaces into such tools. In the specific case of such tools that are implemented as software programs, a plug-in component 106 may be provided. As known in the art, a so-called “plug-in” is a discrete software program implementing additional functions that may be readily integrated into an existing software program using a standardized interface. In the context, for example, of a software development project, such a plug-in implements an interface allowing a user to access and generate messages in a manner similar to the communication template 104, but within an integrated development environment program in which developers are performing software development tasks. Those having skill in the art will appreciate that implementations other than plug-in programs may be equally employed for this purpose.

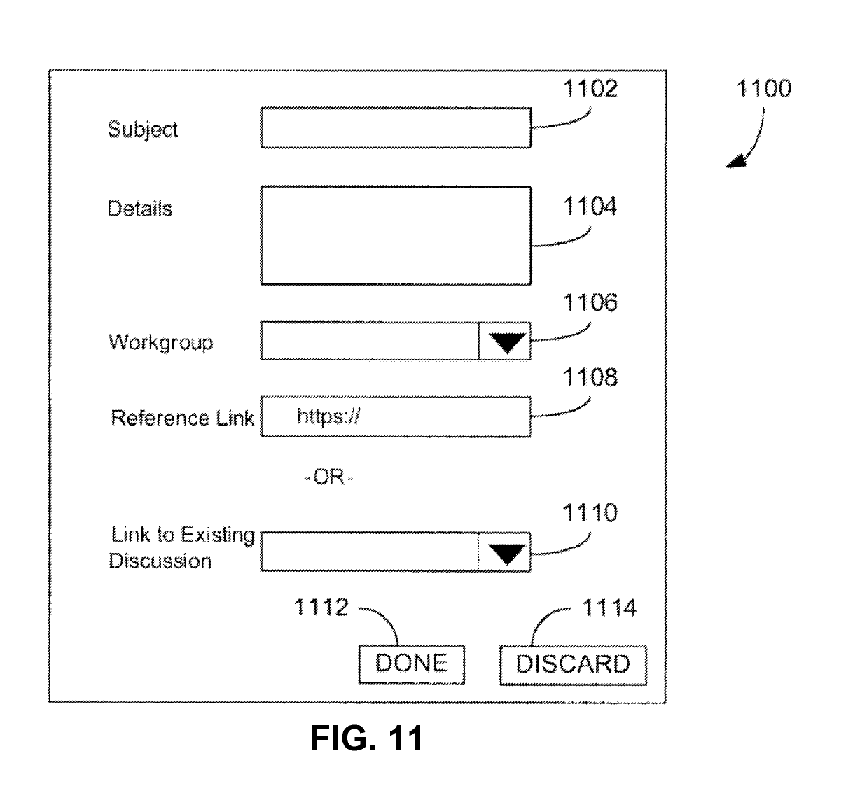

The user interface components also comprise a multi-media capture agent 108 used to generate content files by users of the collaboration system 100. For example, the capture agent 108 may be implemented using Microsoft's “WINDOWS” Media Encoder application. As used herein, a content file may comprise data or information represented in any human-perceivable (preferably, digitally reproducible) form such as text, audio recordings, image recordings, video recordings or combinations thereof represented in any of a number of well-known formats. As such, multiple capture agents, such as those known to the skilled artisan, may be equally employed. As described in greater detail below, the content files generated by the capture agent 108, which is preferably integrated with the dashboard 102 or that may operate as a stand-alone component, may be associated with messages created within the system 100 either concurrently with or subsequent to generation of such messages. Additionally, in one embodiment, an interface, such as that illustrated in FIG. 11 and described in further detail below, may be used to automate the creation of the standardized metadata for use with content files created using the capture agent 108. Furthermore, the content files generated in this manner may also be used as annotations to activity reports generated in accordance with the present invention.

Finally, a status tracker 110 is provided to generate activity reports on behalf of a user. Although illustrated as an “interface” component, the status tracker 110 is preferably implemented in such a manner as to allow automatic, autonomous or semi-autonomous operation. In general, the status tracker 110 is provided access to a project plan 112 (which may be implemented as a data structure stored in a suitable processor-readable medium). The project plan 112 (which may include data/information concerning various milestones, performance goals, progress metrics, etc. that may be useful for project management purposes, as known in the art) preferably includes definitions of one or more events having meaning within the context of a given collaborative project. Each event represents a significant occurrence that may be useful in reporting work status and/or progress. For example, as noted above, in a software development project, such events may concern specific instances of using or handling software program modules, such as checking in/out a program module from a module or code library. More generally, such events may include more mundane occurrences such as (but by no means limited to) powering up/down of a user terminal, accesses to a given portion of a data storage network, instantiation of certain applications, generation of communications to certain other users in the system, etc. Regardless of the exact definition of each pre-defined event, it is preferred that each event be capable of capture (i.e., recognition of its occurrence) in an automatic fashion. That is, it is preferable if the status tracker 110 may capture such events without user intervention (via the processing device in which the status tracker 110 is implemented). For example, referring once again to software development examples referred to above, accesses to the module or code library may be tracked in an automated fashion using known programming techniques. However, it is understood that user intervention in the capture of certain events (e.g., notation of an in-person discussion between two or more collaborators) may be required in those instances in which such automation is not possible.

In a presently preferred embodiment, each time the status tracker 110 captures occurrence of an event (either automatically or with user assistance), information regarding the event is stored. Thereafter, the status tracker 110 may generate one or more activity reports based on the stored event information, which activity reports may be forwarded on to the back end components 120-126 for further handling. Techniques for generating such activity reports, which may simply be a compiled categorized listing of an individual's activities, based on stored event information are well known in the art. Although such activity reports may be generated at virtually any time or aperiodic interval, either automatically or at the instigation of a user or other entity (such as a network administrator), it is presently preferred that they be generated on a periodic basis or scheduled basis. For example, such reports may be generated on a daily basis during normal work days during typical off-hours (e.g., between midnight and 6 AM local time relative to a specific user terminal).

Generally, the back-end components 120-126 operate to manage communications and content files generated by users of the collaboration system 100, including association of messages based on corresponding metadata values, distribution of messages to various users (via corresponding user terminals) of the system 100, as well as the distribution of activity reports. To this end, a communication consolidation component 120 is provided to establish and maintain the associations between the various communications (and, where necessary, content files). In the context of the present invention, an “association” between communications alludes to the circumstance in which messages concern related subject matter and may therefore be connected in some manner to maintain context. In a presently preferred embodiment, such association is carried out through establishment of a logical link, such as a pointer, between stored messages. As described below, the consolidation agent 120 ascertains when to establish such associations based on correspondence of metadata appended to the messages. Associations between messages are established in various manners known to those having ordinary skill in the art. For example, in one presently preferred implementation, messages sent within the system are treated as records in a database. Links between such records are established using a technique known as polymorphic association. In this case, all records in the database are associated via foreign keys (pointers). More specifically, messages are sent to recipients (users, workgroups, and focus areas) via a polymorphic relationship—the communication consolidation component 120 tracks the message primary key (an identification) as well as the primary key for the recipient (another identification) and the type of recipient. It then retrieves messages sent to the current user as well as the workgroups/focus areas that the user belongs to, by default. Similarly, responses to a message are associated via foreign key relationships to other messages. Reference links are simply stored as text in the database record for the message. Likewise, media or content files are related via many-to-many relationships between messages and media files.

In one embodiment, the communication distribution agent 122 operates to route messages to users of the system 100 based on an interest in the subject matter at hand and/or that are the direct, intended recipients of each message. For example, in the context of a software development team, a given manager may send messages concerning “bugs” that arise during development in the software to a group of recipients that have in interest in the subject of “bugs” to the extent that they are impacted by, or may have an impact upon, the subject matter thereof. Additionally, or alternatively, the manager may wish to send the messages specifically to one or more selected recipients. To facilitate such groups (or work groups), individual users of the system may “subscribe” (or, alternatively, be “subscribed” by an initiator of a message) to receive communications concerning certain subject matter intended for a recipient group as indicated by the metadata associated with each communication. In a more specific implementation, users may instead subscribe to specific discussions or topics. In this manner, the present invention provides the ability to automatically build greater team awareness with minimal additional burden on individual team members. Techniques for allowing users to subscribe to work groups, and for managing such work groups, are well known in the art.

A handoff assistant 124 is provided as part of the back end to distribute the activity reports (as well as any associated annotations) received from various users, as well as store such activity reports as individual records in a suitable storage mechanism. In a presently preferred embodiment, each activity report may be distributed to users of the collaboration system (other than the contributing user, whom automatically receives his/her own activity report) based on a subscription system. That is, each user may designate which activity reports he/she would like to be copied on (for example, through configuration of user parameters that may be set via a suitable user interface such as the dashboard 102). Presuming that a given subscriber is authorized to see the desired activity reports, the handoff assistant 124 causes the selected activity reports to be routed to the subscriber using know communication techniques. Alternatively, the recipients of activity reports may be designated in a centralized manner, i.e., through control of a network administrator or project coordinator, using techniques known in the art.

Further, the present invention allows recipients of activity reports to submit their own annotations for association with a given activity report, which association is handled through the handoff assistant 124. For example, a first user may submit his/her activity report (via his/her user terminal, either manually or automatically) for subsequent distribution via the handoff assistant 124. Additionally, the first user may also submit annotations prior to his activity report being distributed to other users (such as a next shift of workers, etc.). Alternatively, a second user, after having received the first user's activity report may decide to submit an annotation concerning the first user's activity report. Using the metadata-based techniques described below, the second user's annotation may be associated with the first user's activity report, thereby allowing all subsequent recipients to benefit from the additional context provided by the second user's annotation.

A project status aggregator 126 operates to collect multiple activity reports received from various users of the system to provide aggregated activity reports. The aggregated activity reports may be distributed to one or more users of the system in the same manner as individual activity reports described above, but with certain restrictions based on user access levels. In alternate embodiments of the present invention, such aggregation may occur on demand or in synchrony (albeit, somewhat delayed) with any periodic or scheduled generation of activity reports within the system. As an example of this latter embodiment, in the case of a collaboration team having separate groups in the United States, France and Japan, individual activity reports may be scheduled for generation at the end of the working day in each country on a daily basis. Shortly after 5 PM (or appropriately designated end of day time) in each country, the project status aggregator 126 may generate aggregated activity reports for the groups of team members in that country and distributed to designated team members in each of the other two countries. In this manner, activity reports for entire groups or subgroups of collaborators may be consolidated into a single report for more efficient review by targeted recipients. Additionally, the data aggregated as a result of these reports can be used to automatically update project plans to help track and manage overall status. Various techniques for automatically updating project plans based on (aggregated) activity reports are known to those having ordinary skill in the art.

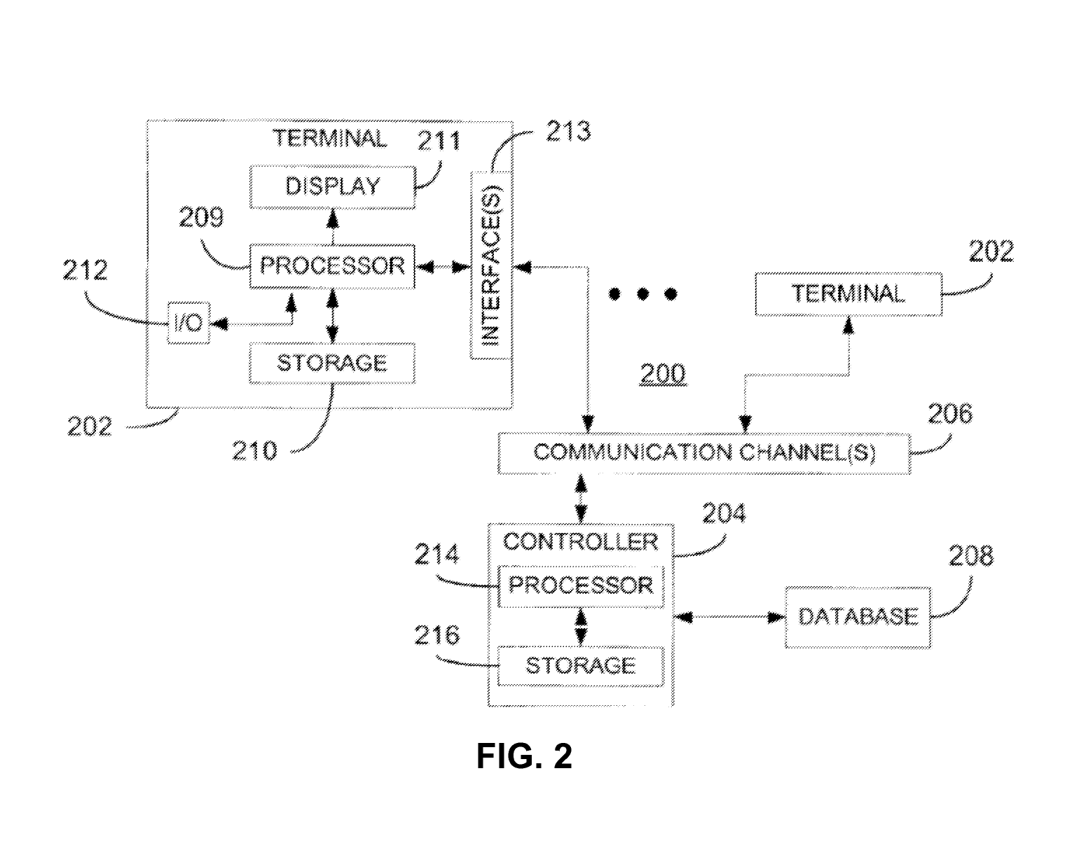

FIG. 2 illustrates a schematic block diagram of a communication system 200 that may be used to implement the collaboration system 100 in accordance with one embodiment of the present invention. Generally, the system 200 comprises a plurality of user terminals 202 in communication with each other and a controller 204 via one or more communication channels 206. In a presently preferred embodiment, each of the user terminals 202 comprises a processor-based device such as a computer (or other device) comprising one or more processors 209 in communication with at least one storage component 210. The processor(s) 209 may comprise microprocessors, microcontrollers, digital signal processors, etc. or combinations thereof operating under the control of executable instructions stored in the storage component(s) 210. The storage component(s) 210 may comprise any combination of volatile/non-volatile memory components such as read-only memory (ROM), random access memory (RAM), electrically erasable programmable read-only memory (EEPROM), etc. The executable instructions stored in the storage component(s) 210 may be particularly used to implement processing as described in greater detail below. However, as known in the art, the user terminals 202 may be implemented, in whole or in part, using other components such as ASICs, programmable logic arrays, etc. that may operate under software or hardware control.

As further illustrated, each user terminal 202 preferably comprises a display 211 in communication with the processor(s) 209. As known in the art, the display 211 may comprise an integral or external display such as a cathode-ray tube (CRT), liquid crystal display (LCD), light emitting diode (LED) display, etc. Techniques for providing display data to a display are well known in the art. In a similar vein, the user terminals 202 preferably include user input/output components 212 as well as one or more communication interfaces 213. The I/O components 212 may comprise any mechanism that allows a user of the user terminal 202 to interact therewith, e.g., a mouse, keyboard, microphone, video and/or still image camera, speaker, etc. The communication interface(s) 213 support the use of the one or more communication channels 206 and typically comprise any combination of hardware and/or software elements necessary to terminate physical links (e.g., Ethernet, wireless, etc.) or communication protocols (e.g., HTTP, SOAP, SSL, TCP/IP, etc.). Techniques for implementing the interface(s) 213 are well known to those having skill in the art.

As noted above, the communication channels 206 may comprise any one or combination of wired or wireless communication channels, depending on the capabilities of the terminals 202 and/or controller 204. Additionally, the communication channels 206 are further defined by the type of communications supported thereby. For example, email communications, voice communications, instant messaging (IM) communications, SMS communications, multimedia messaging service (MMS) communications, etc. may all be supported by different types of communication channels, as known to those of skill in the art. A benefit of the present invention is that the metadata provided in accordance herein allows the collaboration system to organize communications regardless of the underlying type of communication channels employed.

As shown, the controller 204 preferably comprises a processor-based device comprising at least one processor 214 and at least one storage component 216 as described above with regard to the user terminals 202. In a presently preferred embodiment, the controller 204 is implemented using one or more server computers as known in the art. Additionally, the controller 204 is preferably in communication with a database 208 that, as known in the art, can also be implanted using one or more server computers. Generally, the controller 204 implements the functionality described above relative to the back-end components 120-126 whereas the database 208 stores the data (i.e., messages, content files, links there between, activity reports, aggregated activity reports, etc.) sent between user of the system 200.

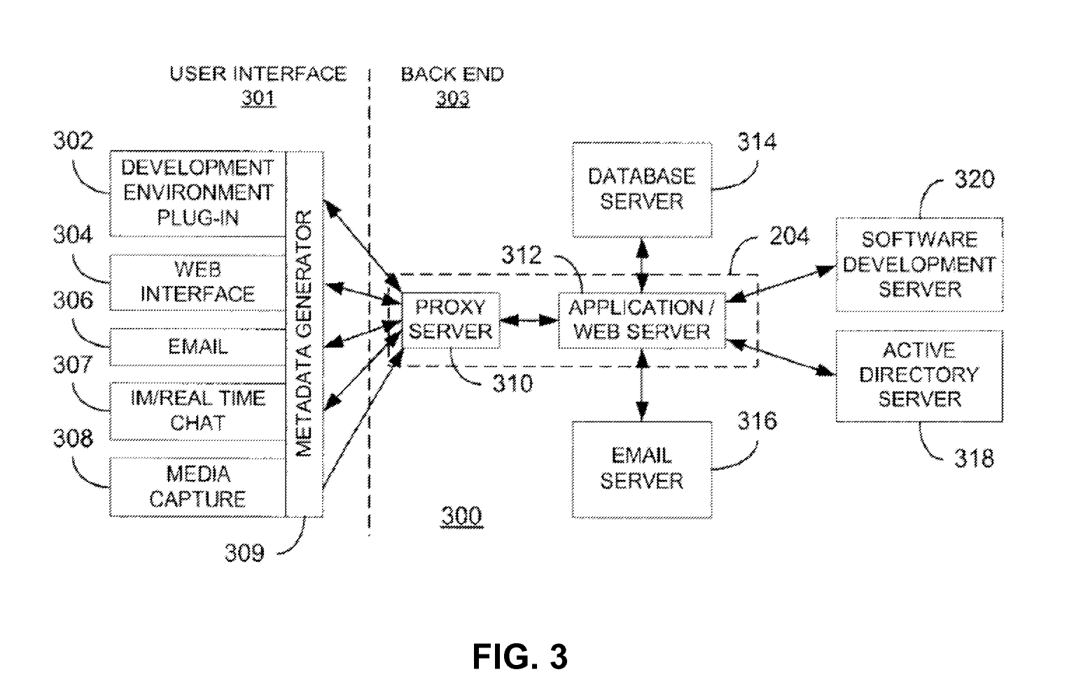

An implementation of a collaboration system 300 showing additional detail regarding implementation of the back-end is further illustrated with regard to FIG. 3. In particular, the collaboration system 300 as shown includes a plurality of user interfaces 301 (only one shown) in communication with the back-end 303. Preferably, the user interface 301 is implemented via the user terminals 202 and carrying out the function of the interface components 102-110 described above. The system 300 illustrated in FIG. 3 is particularly adapted for use in conjunction with software development, although the present invention is not limited to this particular application. Regardless, as illustrated, the user interface 301 includes a development environment plug-in 302, a web interface 304, an email toolbar and interface 306, an instant messaging (IM) or chat interface 307 and a stand-alone media capture interface 308 each operating in conjunction with a metadata generator 309. As known in the art, the development environment plug-in 302 may comprise a plug-in suitable for communicating and operating with a suitable software development program, such as the “ECLIPSE” integrated development environment software program. In general, the plug-in 302 implements substantially similar functionality as the web interface 304, email toolbar interface 306, IM interface 307 or any other interface that provides the ability to generate messages, as described below. The web interface 304 preferably implements the functions of the dashboard 102, described in greater detail below. Similarly, the email interface 306 and/or IM/chat interface 307 preferably implement(s) the functions of the communication template 104, also described in greater detail below. The stand-alone media capture interface preferably implements the functions of the multi-media capture agent 108, described in greater detail below.

The metadata generator 309 operates in conjunction with the various user interface components 302-308 to generate metadata values in accordance with standardized metadata attributes. For example, the metadata generator 309 may receive user selections corresponding to predefined metadata input values, or may comprise received data entered via a user-definable metadata value input field, as described below with further reference to FIGS. 8 and 9. Additionally the metadata generator 309, using known techniques, may populate predefined metadata input fields based on variables known to the system such as date, time, user identification, communication type, etc. Alternatively, more sophisticated techniques can be used to implement the metadata generator 309, particularly techniques that allow metadata to be automatically generated based on analysis of the messages created via the various interfaces 302-308. For example, in the case of communications employing a text format, individual communications can be scanned by the metadata generator 309, using known text parsing techniques, to identify key words that may be used as the metadata. Further still, although the metadata generator 309 is illustrated as a single element in FIG. 3 (reflective of the standardized nature of the metadata generated thereby), in implementation, using techniques known to those of skill in the art, it may be preferable to provide separate components for each of the various user interface components 302-308. Regardless of its implementation, the metadata generator 309 provides metadata values for each communication (message) provided to the back end 303. Through the use of such standardized metadata attributes and values, the present invention is able to create associations between disparate communication channels, thereby creating valuable context to such communications.

As shown, the back end 303 preferably comprises a plurality of server computers 310-320 arranged in a suitable network configuration, a fairly typical example of which is illustrated in FIG. 3. Suitable server computers for implementing the functions of each of the servers 310-320 described below, as well as modifications to the network configuration, are well known in the art of database-backed dynamic web applications. In a presently preferred embodiment, additional implementation techniques are employed, such as using a cluster of virtual servers to implement the application web server 312, or the use of multiple clusters of servers per project collaboration team. Other refinements may be apparent to those having ordinary skill in the art. Typically, each of the servers 310-320 communicates with each other and/or with user terminals via a suitable communication protocol, such as TCP/IP. In the embodiment shown, a proxy server 310 is provided as the interface to the back end 303. In accordance with known techniques, the proxy server 310 provides users of the system 300 indirect access to the services and resources made available by the other back end servers. In the illustrated configuration, the proxy server 310 is in communication with an application web server 312. In a presently preferred embodiment, the combination of the proxy server 310 and the application web server 312 implements the functions of the controller 204 (i.e., the back-end components 120, 122 described above and in further detail below). The application web server 312 is in communication with a database server 314 that stores one or more project profiles, user profiles and communication preferences, identifications o work groups and related/subscribed users, message content, metadata for messages and content files, pointers to content files and the linking information between messages. As known in the art, the email server 316 supports communications between user terminals using an email communication program. More particularly, email communications originating from a given user's terminal (and corresponding interface 301) are first processed by the proxy and web application servers 310, 312 (as described below). Thereafter, such communications can be sent to the intended recipients (e.g., workgroups and/or specific users) via the email server 316 using well known techniques.

The additional servers illustrated comprise an active directory server 318 in communication with the application web server 312. As known in the art, the active directory server 318 allows one or more system administrators to control configuration/operation of the various components within the system 300, including the user terminals. A software development server 320 is also shown in communication with the application web server 312. In the context of software development projects, the software development server 320 may implement a suitable workflow automation tool such as IBM's “RATIONAL” “CLEARQUEST” program. Of course, other servers running applications appropriate for use on different types of collaborative projects may be equally incorporated, using known techniques, as dictated by the particular needs of such projects.

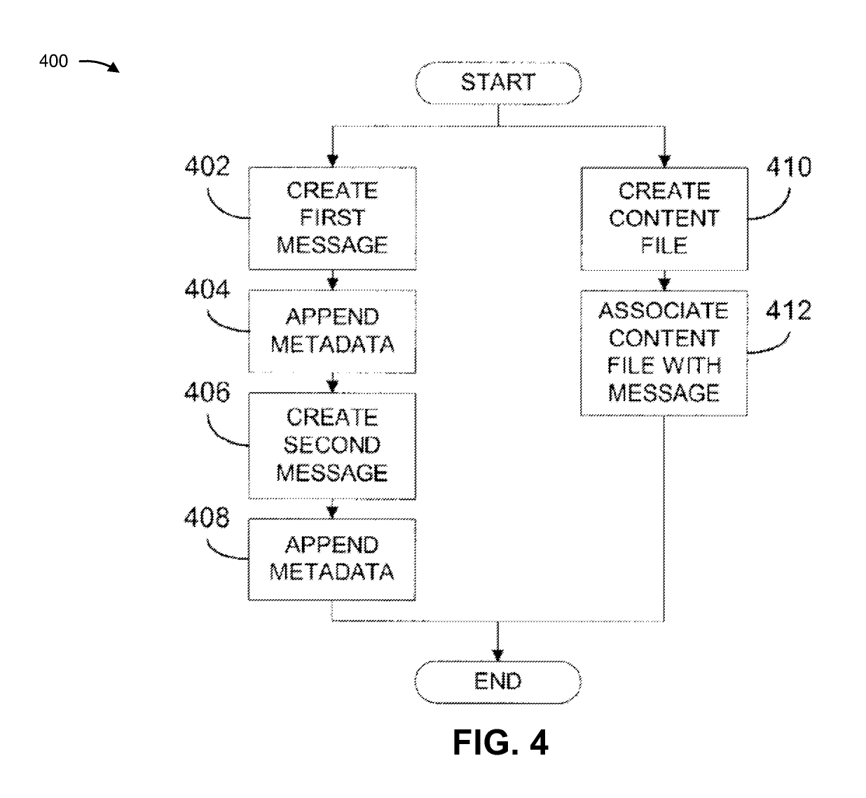

Referring now to FIG. 4, a flowchart illustrating operation of a user terminal in accordance with the present invention is shown. As noted previously, the operations illustrated in FIG. 4 are preferably implemented using stored, executable instructions that control operation of one or more suitable processors. As shown, the processing of FIG. 4 is divided into two separate, parallel paths that may be carried out substantially simultaneously or at different times. Thus, along a first path, processing begins at block 402 where a first message is created by a user of the terminal using a message creation component. As known in the art, a message can be created in any of number of ways depending on the format of the message to be created. For example, an email message can be created through the use of a suitable email program, such as Microsoft's “OUTLOOK” email program, by typing the message using a keyboard. Similarly, an instant messaging program may be used to create an instant message or the dashboard 102/web interface 304 may be used to create a new message, as described below. Regardless of the manner in which the first message is created, processing continues at block 404 where a first plurality of metadata values are appended to the first message. As used herein, appending metadata to a message encompasses inclusion of the metadata in the message itself. For example, the metadata may be transmitted within the same electronic message “envelope” as the message content itself, or may be directly embedded in the message content. Alternatively, the metadata may be stored separately from the message content and “appended” by virtue of a logical link (e.g., pointer values to physical storage locations) between the two. As noted previously, the metadata values correspond to at least some of a plurality of metadata attributes that have been standardized in accordance with the needs of the users of the system. For example, in a software development environment, such standardized metadata attributes may be categorized by type of communication being submitted (e.g., regarding a problem found, asking a question concerning requirements, making an announcement, etc.); by the groups potentially impacted by the communication (e.g., the development group, management, the testing group, etc.); by relevant references (e g , links to other systems or other users within the system); and/or by status (e.g., priority, urgency, state of completion, etc.) Additional system generated metadata may include the date and timestamp of message creation or modification, the user creating or modifying the message. Once again, the particular standardized metadata attributes are not necessarily limited to those described herein, and may be particularly selected according to the needs of a particular project.

Thereafter, at blocks 406 and 408, the processing described above relative to blocks 402 and 404 may be respectively repeated for the creation of a second message and appending of a second plurality of metadata values. Note that the first and second messages do not have to be created by the same message creation component nor do they have to be communicated by the same communication channel. So long as they both have their standardized metadata values appended thereto, the fact that they have been created using different message types (e.g., email, instant messaging, web interface, plug-in interface, etc.) will not affect the ability of the instant collaboration system to establish context between the two messages. That is, assuming the first and second message are related in some fashion, the first and second pluralities of metadata values should compare favorably such that the first and second message may be subsequently associated together.

In parallel with the first path described above, the second path illustrated in FIG. 4 begins at block 410 where a user creates a content file. As noted above, various tools may be employed to create a content file depending on the format of the content file to be created, i.e., text, audio, images, video, combinations thereof, etc. Additionally, the content file may be created well before or after or substantially at the same time as a message with which it is subsequently associated. As noted previously, corresponding standardized metadata values are preferably appended to content files when such content files are added to the collaboration system, i.e., when the content files are created or uploaded. To this end, a suitable interface may be provided to ensure uniform capture of the standardized metadata, an example of which is further illustrated in FIG. 11.

As shown in FIG. 11, the interface 1100 comprises a number of user input mechanisms (e.g., text boxes, drop down menus, etc.) that allow a user to enter metadata input values. Note that the examples illustrated in FIG. 11 are not intended to be exhaustive of such input mechanisms or the types of metadata that may be captured. In the illustrated example, a text box 1102 is provided for capturing a subject indicator, e.g., the subject matter to which the content file relates. In a similar vein, a details text box 1104 is provided to capture additional information concerning the content file. That is, the details text box 1104 is intended to be freeform, allowing users to provide information/metadata that would be useful to viewers. For example, in a software development project, a user may use this functionality to walk the viewer through a functional problem via a screencast (i.e., a digital recording of computer screen output, often containing audio narration), where the text box 1104 might be utilized to provide prerequisite steps. A drop down menu 1106 is provided as a means for selecting a work group. In this implementation, the drop down menu 1106 provides a predefined list of available work groups (e.g., in the context of a software development project, a Project Management group, Technical Architecture group, Requirements group, Application Design group, Development group, Testing group, Communications group, Deployment group, etc.). A reference link text box 1108 allows a user to enter, in this example, a website address of a website that includes additional relevant information. Of course, other types of addresses (e.g., internal network addresses, etc.) could be equally employed. Further still, a discussion pull down menu 1110 is provided that allows a user to select a particular discussion (as described below) to associate the content file with. In this instance, a list of discussions are maintained (for example, by the controller 204), which list is used to populate the various pull down menu selections. Finally, suitable buttons are provided that allow a user to accept his/her selections 1112 or discard (cancel) 1114 them in accordance with well-known user interface paradigms.

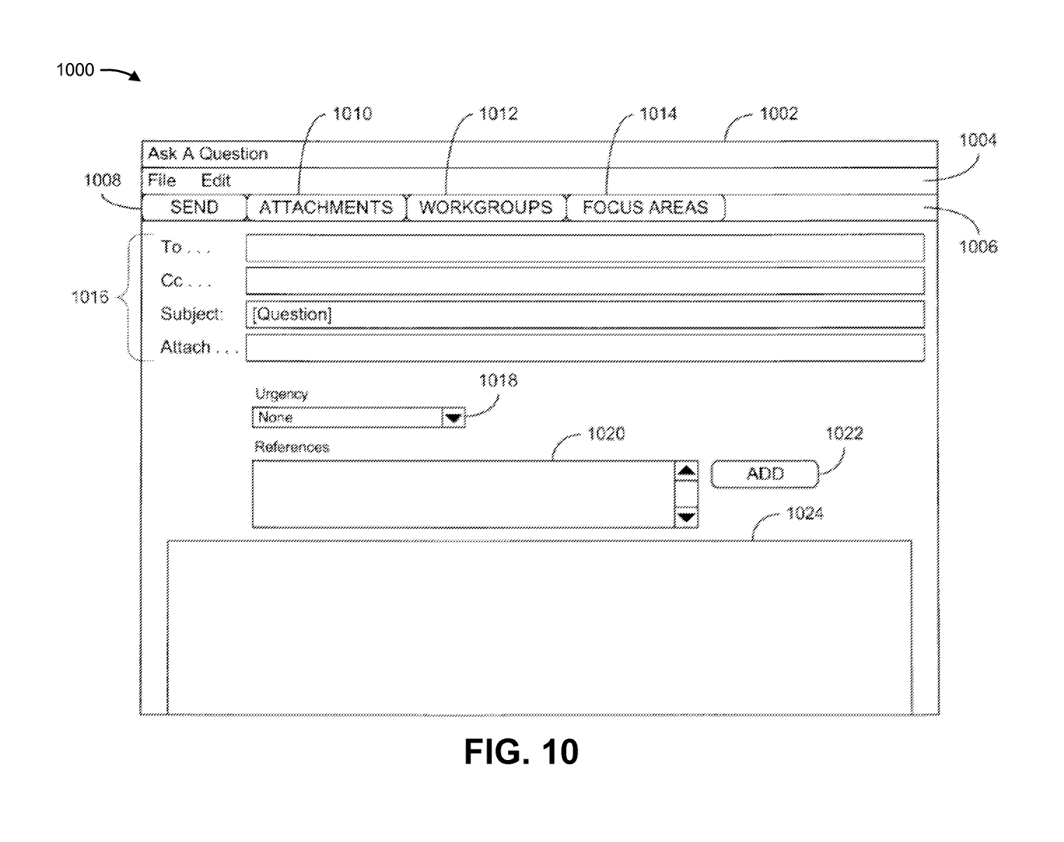

The content file created at block 410 is preferably stored at a centralized location, e.g., at the web application server 312, although it is understood that any suitable storage means in virtually any location may be used for this purpose. When being stored, the content files may be uploaded automatically (after being created locally at a user terminal) when the file is created through the system applications, e.g., the media capture agent 308, or created locally by the user in an application external to the system and uploaded, e.g., to the web server 312, at a later time through the dashboard 102. Regardless, at block 412, the content file thus created and stored may be associated with a message, such as a message created in accordance with blocks 402-408 as described previously. Once again, the association of the content file may be carried out through actual co-storage of the message and the content file, or, in a presently preferred embodiment, via logical links between the two (which links are preferably stored, along with the metadata in the database 314). Also, the step of associating the content file with the message may occur substantially simultaneously with or at any time after creation of the message. For example, as described below relative to FIGS. 8 and 10, either the dashboard 102 or communication template 104 may be used to associate the content file with the message.

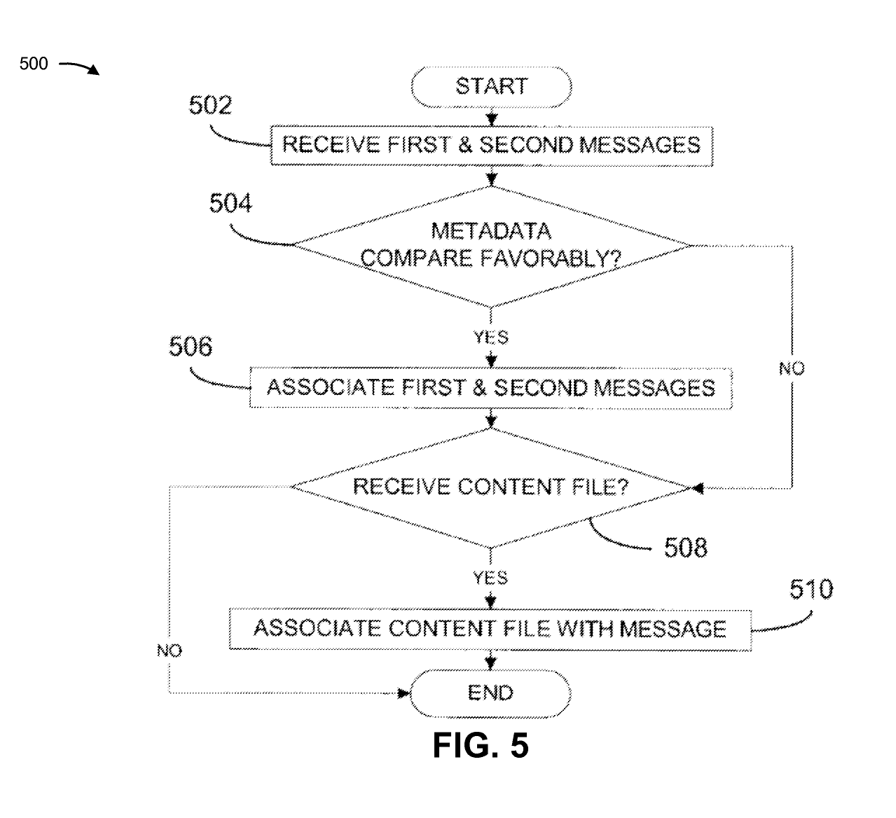

Referring now to FIG. 5, a flowchart illustrating operation of a controller in accordance with the present invention is shown. As noted above, the operations illustrated in FIG. 5 may be implemented using stored, executable instructions that control operation of one or more suitable processors. Beginning at block 502, the controller receives first and second messages from user terminals. Both the first and second messages have metadata appended thereto as described above. Note that the first and second messages may be received at the controller within a relatively short period of time or at substantially different times, e.g., weeks or even months apart. In order to determine whether the first and second messages should be associated with one another, a comparison of their respective metadata values is undertaken at block 504. As known to those having skill in the art, a variety of techniques for comparing metadata values with each other are available and further description here is not necessary. More importantly, whether the two messages should be associated with each other depends on the relative favorability of the comparison performed at block 504. The standard for assessing such favorability is a matter of design choice. For example, in a presently preferred embodiment, substantially identical metadata values (of at least a subset of the possible standardized metadata attributes) are required. More specifically, it is currently preferred to find a favorable comparison when a given message is a reply to a previous message, hence resulting in virtually identical metadata values, or when the metadata values corresponding to work groups are identical. In this latter vein, association may be proper where a relatively small number of high priority metadata values substantially match. For example, two emails having different creation times and showing different “subject” lines may nevertheless be properly associated together if they have the same author and recipients and contain one or more identical keywords. The present invention is not necessarily limited by the nature of the test used to determine the existence of a favorable comparison.

If the comparison of block 504 is favorable, the first and second messages are associated with each other at block 506. As noted above, this is may be accomplished by establishing one or more logical links or pointers (e.g., through the use of foreign keys) between the messages. For example, each message could include a pointer to the physical location in storage of the other message. References to other discussions (i.e., threads of messages) may likewise be associated via appropriate pointers. In the above-mentioned case of reply messages, such pointers are not necessary as known to those of skill in the art. After establishment of the association at block 506 (regardless of how its implemented), or if the comparison at block 504 was unfavorable, processing may continue at block 508 where it is determined whether a content file has been received by the controller. The manner in which the content file is received may vary, including directly receiving the content file as in the case of an included email attachment, or indirectly as in the case of receiving a reference (e.g., a pointer) to the content file within the centralized, back end storage (e.g., the web application server 312) or in a local user terminal. In a presently preferred embodiment, the dashboard 102 may be used at a user terminal to manipulate graphical representations of content files and thereby associate them with specific messages. Regardless of the manner in which the controller receives the content files, processing thereafter continues at block 510 where the content file is associated with a message. Those of skill in the art will recognize that individual content files could be associated with more than one message. Once again, such one-to-one or one-to-many association may be accomplished through the use of pointers to storage locations. Other techniques may be used as a matter of design choice.

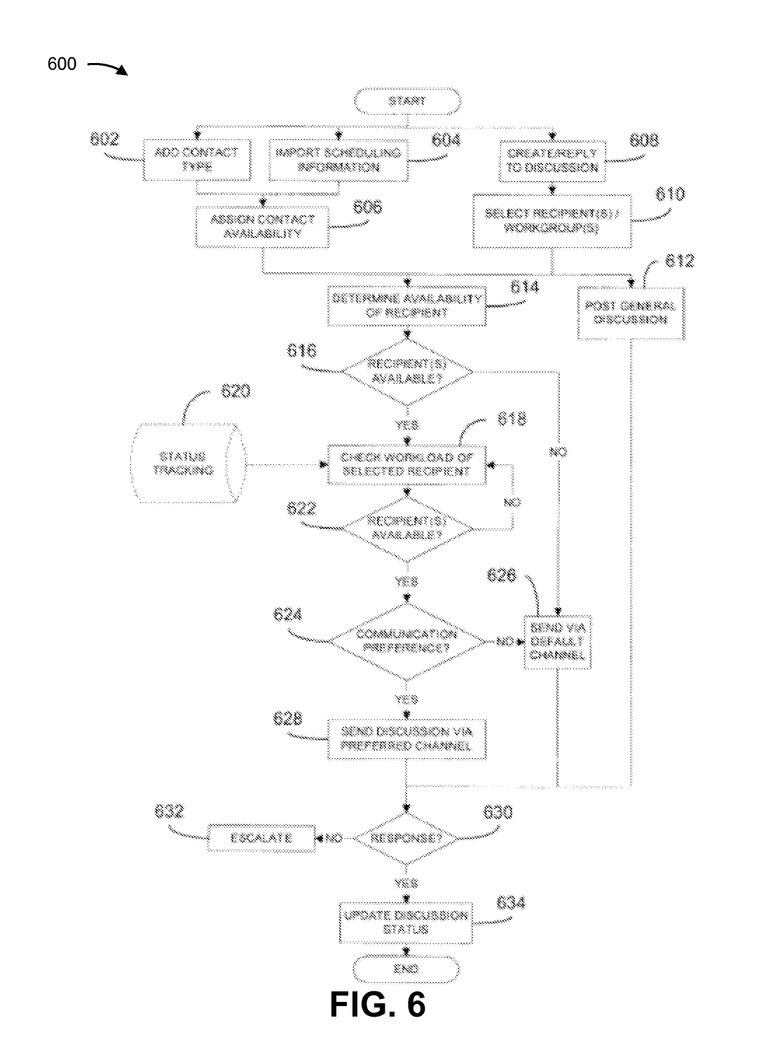

In another aspect of the present invention, the distribution of messages is controlled, at least in part, by the particular members of a group designated to receive the messages, the preferred communication channels of such members and the workload of each recipient. An example of such a process in accordance with a presently preferred embodiment is illustrated in FIG. 6. Once again, the processing illustrated in FIG. 6 is preferably implemented using appropriately programmed processors of the types described above, both within the user interface 301 and back end 303. As illustrated, the various processing blocks 602-634 may be generally grouped into three distinct groups. In a first group, comprising blocks 602-606, information concerning availability and preferred communication channels of a user is managed. In a second group, comprising blocks 608-610, initiation of discussions, as described below, is provided. Finally, in the third group comprising blocks 612-634, distribution of specific messages, including delivery to specifically designated recipients is further illustrated.

Beginning at block 602, a user of the system may provide any necessary information to configure a particular contact type, i.e., communication channel. That is, in a presently preferred embodiment, a user can designate specific communication channels to be used to contact that user in accordance with rules or preferences of the user's own design. In a preferred embodiment, the dashboard 102/web interface 304 is used for this purpose, as described below. Thus, for example, during normal business hours in which the user does not have previously scheduled appointments, the user may designate that his/her office email account should be used to receive incoming messages without any further attempts to alert the user. Conversely, after normal business hours or during periods of time during which the user has previously scheduled appointments, the user may designate that, in addition to routing all incoming messages to his/her email account, a message should also be sent to the user's mobile phone via, for example, SMS. Those having ordinary skill in the art will appreciate that known techniques may be used when establishing such rules. Generally, the configuration information provided by the user at block 602 may be stored in any suitable storage device although, in a presently preferred embodiment, it is stored by the database 208.

In parallel, at block 604, scheduling information for the user may be imported into the system, i.e., via the web server 312. In a presently preferred embodiment, the scheduling information may comprise information taken from an electronic calendar or similar mechanism. As known in the art, such scheduling information is indicative of the time, places, etc. of appointments for a given user and may be encoded in a conventional manner. Regardless, at block 606, contact availability for the user is established based on the imported scheduling information from block 604 when overlaid with the contact rule types established at block 602. In this manner, the present invention allows users to very specifically tailor the communication channels at their disposal to their personal needs and schedules.

Within the second group of blocks described above, i.e., concerning the initiation of discussions, processing begins at block 608, where a user may initiate or respond to a discussion using any of the above described user interfaces, e.g., the dashboard 102, communication template 104 or plug-in interface 106. Using known techniques (such as predetermined pull-down menu entries or the like in a graphical user interface), the user can elect to create a new discussion or reply to an existing discussion. As used herein, a discussion is a thread of associated messages (and, possibly, content files, as described above) concerning a particular topic or subject. The “breadth” of such discussions, i.e., the size of the group of desired recipients, may be controlled in part through the manner in which the discussions are initiated. For example, by initiating a discussion to a specific workgroup, as illustrated at block 610, a relatively broad audience may be established initially. Alternatively, or in addition, selection of specific, individual recipients of a discussion allows the creator of a discussion to more closely manage its intended audience. Regardless, as described below, the controller 204, when it receives a message to be distributed to designated recipients and workgroup members, undertakes a two-pronged delivery process in which it evaluates each recipient's availability for individual delivery of the message, as well as a general “posting” of the message to a discussion thread that is always available via the dashboard 102, as described below.

Within the third group of blocks, i.e., concerning the distribution of messages to their designated recipients, processing is once again split along two parallel paths. Along the first path, embodied by block 612, all messages (whether the beginning of a discussion or in response to an existing discussion), are posted to the discussions to which they pertain. In a presently preferred embodiment, this includes publishing the message as part of a discussion to be displayed on the dashboard 102. That is, using the association process described above, the message is posted as part of a discussion thread based on its association with one or more messages in that thread.

In parallel, and assuming individual recipients of a message were designated at block 610, processing proceeds in parallel at block 614 where the controller 204 determines availability of recipients of the message, including individual members of any designated work group, by reference to such recipients' respective scheduling information. If, at block 616, it is determined that individual recipients are not available, processing continues at block 626 where the message is sent via a default communication channel to such recipients. Such default communication channel is preferably a relatively ubiquitous, non-intrusive channel type, such as email, although other channels may be used for this purpose as a matter of design choice.

In one aspect of the present invention, the distribution of messages to designated recipients may be based, at least in part, upon the workloads of each designated recipient. This is illustrated at block 618 where the individual workloads of each selected recipient is determined. In a presently preferred embodiment, individual workloads are assessed through reference status tracking data 620. Status tracking information refers to status reports of individual users concerning their daily activities including, but not limited to, goals achieved, activities engaged in, etc. as provided by individual users of the system. Virtually any method (although preferably automated) for gathering such information may be employed by the present invention. For example, a presently preferred technique for generating such status tracking information is disclosed in co-pending U.S. patent application having attorney docket number 33836.00.0140, filed on even date herewith and incorporated herein in its entirety. Those having ordinary skill in the art will appreciate that various other techniques for determining the workload of individual recipients may also be used with the present invention. In accordance with this embodiment, those recipients having a favorable workload are selected to receive the message. For example, a designated recipient having a currently excessive workload may be excluded from receiving the message so as to minimize the burden placed on that particular user. Conversely, the user, having a currently light workload may be selected as a recipient as it is presumed that the user will have the necessary time to consider the message. Those having skill in the art will appreciate that various techniques may be employed to determine the favorability of an individual's workload. For example, in one embodiment, at least three factors are combined to assign each recipient an individual score, including the recipient's activity as indicated by the specific tasks assigned to the recipient per a project plan as well as previous messages sent to the recipient. Additionally, task alignment between the subject matter of the message and the designated recipient's assigned task may also be assessed for this purpose. By combining metrics representative of these three factors using known techniques (e.g., total score, average, weighted average, etc.) the individual scores may be assigned and compared to a suitable threshold selected as a matter of design choice. Regardless of the manner in which workload is determined and assessed, processing continues at block 622, it is determined whether each individual recipient is available based on his/her workload per block 618.

Thereafter, processing continues at block 624 where it is determined, for each remaining recipient, if the recipient has a communication preference for receiving such messages. If not, processing continues at block 626 where the message is sent via the default communication channel as described above. If, however, the recipient has designated a preferred communication channel, processing continues at block 628 where the message is sent to each such recipient via his/her preferred channel.

Regardless whether a given message has been only generally posted as per block 612, sent via a default channel to as per block 626 or via preferred channel as per block 628, processing thereafter continues at block 630. At block 630, it is determined whether a response has been received (by the controller) to the message posted at block 612 or sent at block 626, 628. In one embodiment of the present invention, it may be desirable to escalate the importance of the message in the event a response has not been received to that message, as illustrated at block 632. In this context, such escalation may include sending the message to other recipients as indicated by a project plan. For example, the project plan may include listings of each user's supervisor and the supervisor's contact information. In one embodiment of the present invention, the threshold for determining whether to escalate a given message is based, at least in part, upon designations assigned by the message initiator. For example, a specific period of time for response may be assigned, such as “within the next two hours”, etc. Alternatively, specific priorities may be assigned with the understanding that higher priority messages are escalated more quickly than lower priority messages (in accordance, for example, with a defined escalation scheme defined by a project plan). Further still, project structure according to the project plan may be employed for targeting specific, additional recipients. Thus, if escalation is required, the message could be sent to the supervisors of one or more of the originally intended recipients. In the process of selecting such additional recipients according to the escalation need, the previously described process of assessing a recipient's availability (i.e., immediate availability per his/her calendar, work load availability per the multifactor assessment) may employed. If, on the other hand, a response is received at block 630, processing continues at block 634 where the status of the discussion to which the message pertained is updated. For example, such update of status may include closing out the discussion, raising priority of the discussion, or any other appropriate status update.

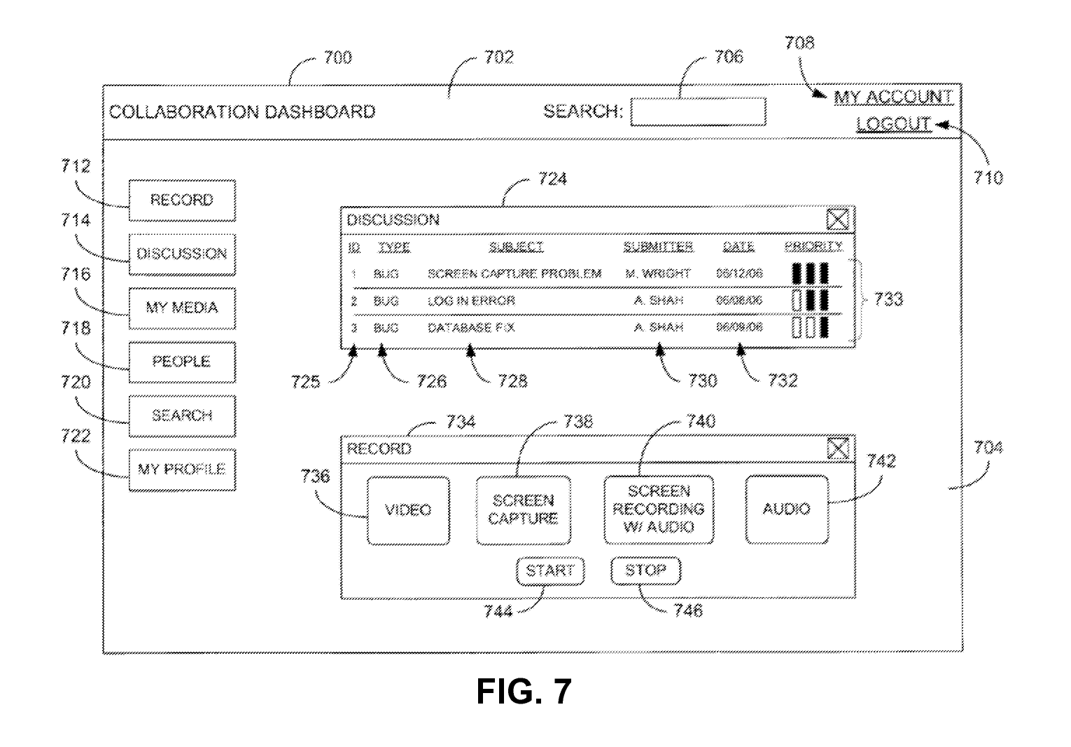

Referring now to FIGS. 7 and 8, an exemplary web application-based user interface 700 in accordance with the present invention is further illustrated. Techniques for implementing such graphical user interfaces are well known to those having ordinary skill in the art. In accordance with the present invention, the interface 700 is an implementation of the dashboard 102 Referring now to FIGS. 7 and 8, an exemplary web application-based user interface 700 in accordance with the present invention is further illustrated. Techniques for implementing such graphical user interfaces are well known to those having ordinary skill in the art. In accordance with the present invention, the interface 700 is an implementation of the dashboard 102

Within the display window 704, a plurality of user selection mechanisms 712-722 are illustrated as selectable buttons. In particular, a Record button 712 is provided that may be selected to instantiate one or more media capture agents as described above. For example, assuming that the Record button 712 has been selected, a record window 734 is illustrated having displayed therein a further plurality of selectable buttons, including a video recording selector 736 that may be used to instantiate a video recording program, a screen capture selector 738 that may be used to capture an image of a screen on a computer, a screen capture and audio recording selector 740 that may be used to capture one or more screen shots while simultaneously recording audio, and an audio selector 742 that may be used to initiate audio recording only. Other recording types or combinations of types may be equally employed as a matter of design choice. Start and stop buttons 744, 746 are provided to initiate and terminate recordings after the desired recording mode is selected.

A Discussion button 714 is provided to instantiate a discussion window 724 that may be used to view user-selectable discussions (i.e., one or more associated messages and, possibly, content files) relevant to a user (or a group of which the user is a member). By selection of an individual discussion item, a window setting forth the relevant messages (and associated content files) may be displayed. In a presently preferred embodiment, each item may include a variety of information including a discussion identifier 725 and a discussion type 726. The identifier 725, preferably automatically provided by the controller managing the discussions, may comprise any indicia that allow a discussion to be uniquely identified (in the illustrated example, a unique numerical identifier), and the discussion type 726, preferably user-configurable, sets forth some attribute value of the discussion useful for categorizing separate discussions. In the example shown, each of the discussions is of the “Bug” type, meaning that the discussion concerns a problem identified in the software being developed by the collaborative team. Of course, other types may be defined as a matter of design choice. Note that the example in FIGS. 7 and 8 illustrate only three discussions; in practice, many more discussions (or fewer) may be displayed using, for example, a scrolling window. A subject indicator 728 allows for a simple, short description of the subject matter of the discussion. The submitter and date indicators 730, 732 respectively indicate the identity of the person that initiated the discussion and the date on which the discussion was initiated. Finally, priority indicators 733, which may be associated with corresponding ones of the discussions, may be provided as a visual indicator of the relatively importance or urgency of each discussion. As described below, the priority of a discussion may be set by the user initiating the discussion or modified by the initiating user (or, alternatively, other users) at a subsequent time using, for example, the corresponding priority indicator 733 presuming that the indicator 733 is made user-selectable and modifiable using known techniques. In a presently preferred embodiment, the attributes 725-733 of each discussion may be used to sort and/or filter the displayed discussions in accordance with known sorting and filtering techniques.

With further reference to FIG. 8, the My Media button 716 is used to instantiate a media window 802 that allows a user to view information concerning one or more media (content) files created or received by that user. For example, as shown in FIG. 8, the listing for each media file may include a media file identification 803 that comprises any indicia that may be used to uniquely identify the corresponding media file. A media type indicator 804 is also provided to help identify the type of media used to record the content file, e.g., audio, video, screen image, etc. A subject indicator 806 provides a brief textual description of each content file. As before, the submitter and date indicators 808, 810 indicate who created the file and when the file was created.

One feature of the present invention is the ability to associate the media or content files with particular messages or discussions via the web application interface 700. In particular, so-called “drag-and-drop” functionality may be employed to allow a user to drag a file icon 812 using an input selector 811 to a targeted discussion 814 and, by this action, cause the media file underlying the file icon 812 to be associated with the targeted discussion 814. Using known communication techniques, this action may cause a message to be sent to the controller 204 indicating that the media file is to be associated with the discussion or message. In this manner, significant context may be established for each given discussion, thereby allowing team members to develop better understanding of the communications being exchanged.

In addition to the buttons 712-716 described above, a People button 718 may be provided thereby allowing a user to view or search a listing of other collaborators using the collaboration system. Using this mechanism to identify specific collaborators, profiles of each selected collaborator may be viewed to view current profile information. For example, such profiles may include a picture of the collaborator, contact information (including preferred contact modalities), titles, work locations, group memberships, time zone information and presence information (e.g., currently logged in, busy, etc.) of each collaborator. In this manner, individual collaborators may quickly learn about each other. A Search button 720 provides an alternate method to access search functionality and the My Profile button 722 allows each user to update his/her own personal profile information, which may include designations of what types of profile information may be viewed by different entities, e.g., certain key personnel may be allowed to view a manager's home contact information whereas other personnel may be restricted from viewing such information. In accordance with blocks 602 and 604 described above relative to FIG. 6, the My Profile button 722 may be used to invoke the necessary user interface(s) (as known in the art) to manage/edit communication channel preferences and rules regarding same, as well as the user's scheduling information.

Referring now to FIG. 9, an implementation of a communication toolbar is illustrated in the form of an exemplary email interface 902. In particular, the email interface 902 is based on the familiar Microsoft “OUTLOOK” email program interface and includes a title bar 904, a menu bar 906 comprising the typical email menu items and one or more toolbars 908, 910, and a display window 912 (in this case, displaying a user's “Inbox”) as known in the art. Additionally, a user input mechanism 914 is provided (in this case, in the form of a pull down menu) that allows a user to select one of a plurality of selectable predefined metadata input values 916. As known to those having skill in the art, user-selectable input mechanism 914, rather than providing a predefined list of potential metadata values 916, may instead comprise a user-definable metadata value input mechanism such as a blank text box. Additionally, although a single input mechanism 914 is illustrated in FIG. 9, it may be desirable to include a plurality of such mechanisms (either identical or different in operation) to accommodate the possibility of entering multiple metadata values. This is further illustrated with respect to FIG. 10.

FIG. 10 illustrates a message window 1002 that may be instantiated in response to selection of the “ask a question” metadata value 916 illustrated in FIG. 9. As shown, the message window I 002 includes the familiar menu bar 1004 and message editing window 1024 employed by many email programs. A control bar 1006 is provided that sets forth various user-selectable control buttons including a send button 1008 and file attachment button 1010, which may be used to append content or media files to the message, as known in the art. In furtherance of the creation of metadata, a workgroup button 1012 and a focus area button 1014 are also preferably provided. The workgroup button 1012 allows a user to select from a list of predefined workgroups, e.g., Project Management, Technical Architecture, Requirements, Application Design, Development, Testing, Communications, Deployment, etc. that reflect the particular organization of the collaborative team, with each possible selection comprising a potential metadata value. In a similar vein, the focus areas button 1014 may allow further definition of relevant entities within each workgroup as designated by particular functions within each workgroup, or particular issues that are typically associated with a given workgroup. In a presently preferred embodiment, both the workgroup and focus area entries may be defined as a set of customized values. In this manner, useful, context-building metadata concerning the message may be captured and stored for use as described above.

Further metadata input mechanisms are illustrated in the form of addressing inputs I 016 comprising the familiar data entry fields for recipients of the message (the “To” and “Cc” fields), the subject of the message (in this instance, automatically prefilled by a “Question” indicator as dictated by the original selection of the “ask a question” metadata value) as well as an attachment input field. An urgency input selector 1018 is provided to allow a message creator to set an urgency or priority level for the message using, in this instance, a drop down menu. Further still, the combination of a references field 1020 and corresponding add button I 022 allows a user to selectively add additional information to the message, such as information concerning relevant website addresses, contact people or content files. Each of these input mechanisms constitutes an additional source of metadata values that may be appended to the resulting message.

As noted previously, while the example of FIGS. 9 and 10 concerns an email interface, similarly functioning interfaces may also be used to develop templates for other communication modalities, such as the above-mentioned IM, SMS or MMS channels using techniques known to those of skill in the art. Additionally, any combination of the input and display mechanisms described above with regard to FIGS. 7-10 may be incorporated into a suitable plug-in component 106 that generates an appropriate interface within the corresponding main program for which it is designed, again using known implementation techniques. For example, in the context of a software development tool, an interface may be provided that lists the same information shown in the discussion window 724 described above. In this manner, a more effective presentation of development-related communications may be provided.

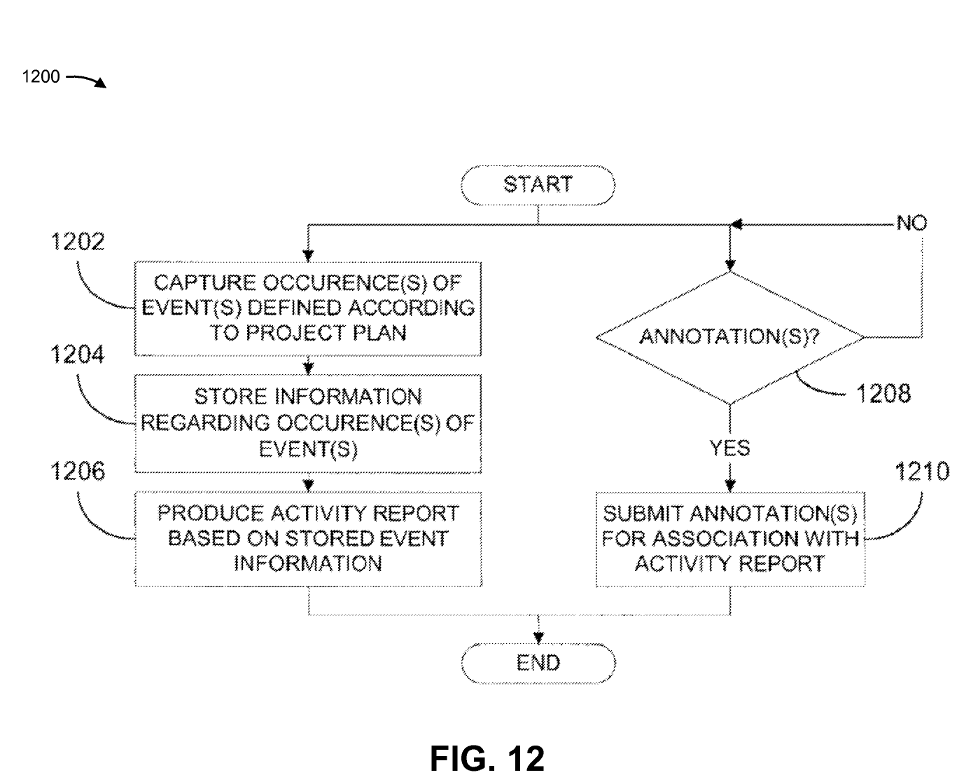

Referring now to FIG. 12, further processing concerning generation of activity reports by user terminals is described. As noted above, the operations illustrated in FIG. 12 may be implemented using stored, executable instructions that control operation of one or more suitable processors. As shown, the processing of FIG. 12 is divided into two separate, parallel paths that may be carried out substantially simultaneously or at different times. Thus, along a first path, processing begins at block 1202 where occurrences of one or more events, defined in accordance with a project plan, are captured by the user terminal. As noted above, the occurrence of such events is preferably detectable in an automatic fashion, thereby relieving a user from having to manually enter activity data. In accordance with presently preferred embodiments of the present invention, such events may include completion of a designated task and/or usage of an element within the collaboration network. As used herein, an element may comprise any unit or collection of units of data stored within a network, such as a content file, a software module, etc. and usage thereof may constitute any of a number of well-known operations, including but not limited to accessing, reserving, modifying, copying, etc. such elements. Although it is preferred that event capture occur in a substantially automatic fashion, this does not preclude the possibility of “manual” event capture. In this instance, the processing at block 1202 may comprise receiving input from a user of the terminal concerning the event. This may occur in the case of an activity or task that is not performed with the use of the user terminal, or that is not otherwise manifested to the user terminal. By way of non-limiting example, this may include entering information regarding meetings or other oral conversations, etc.

For each event captured at block 1202, corresponding information concerning the event is stored by the user terminal at block 1204. For example, in a presently preferred embodiment, such information may include, but is not necessarily limited to, a category of event type, an event description, the time of the event, the application in which the event occurred as well as the identity of the user giving rise to the event. Techniques for generating event information of this type are well known in the art. The particular format used for the event information is a matter of design choice. Likewise, the storage location of the event information may be a matter of design choice dictated at least in part by the location at which it is generated. For example, the event information may be stored in a suitable storage device of the user terminal or other local storage device. Alternatively, the event information may be stored within a suitable storage device, such as a network server, within the collaboration system itself.

Regardless of the storage location or format of the stored event information, processing continues at block 1206 where an activity report is generated based on the stored event information. Techniques for generating such activity reports (based on the access and mining of process log files of relevant applications to capture the required data for all events to be included in the activity reports) are well known in the art. Likewise, the content and format of activity reports are well known to those having skill in the art. In a presently preferred embodiment, the information included in the activity reports is categorized by type, application and time, although other formats are equally possible. As noted previously, the generation of activity reports may occur at virtually any point in time ranging from an on-demand, asynchronous basis to a fully automated, periodic basis. Once generated, an activity report may be provided to a controller for further distribution using any of a number of techniques. For example, once generated, an activity report may be stored locally to the processing device (e.g., user terminal) that generated it for subsequent provision to the controller in response to a request or polling by the controller. Alternatively, in a “push” embodiment, the activity report may be automatically provided to the controller without further intervention by the controller.

In parallel with the first path described above, the second path illustrated in FIG. 12 begins at block 1208 where it is determined whether any annotations to an activity report have been provided. As used herein, an annotation is essentially a content file that is targeted for association with an activity report, as opposed to a message. As such, annotations may be represented in any of the formats previously described and generated in the same manner as content files. In the present context, provision of an annotation may be manifested in a variety of ways. For example, a user interface such as that illustrated in FIG. 8 may be employed whereby a user manipulates a graphical interface to associate an annotation with an activity report.

Regardless of the manner in which they are provided, processing continues at block 1210 where the annotations are submitted for association with one or more activity reports. Association of an annotation and an activity report may occur using any of the techniques described above for associating content files with messages. For example, and with reference to FIGS. 9 and 10, where the activity report is represented in an email format, an annotation may be associated with an activity report as an email attachment. In cases such as this, the annotation is associated with the activity report locally by the processing device generating the activity report. Alternatively, the association may be accomplished by a remote device, such as a controller, in the case where the annotation (and any metadata necessary to establish the association) has been provided directly to the controller.

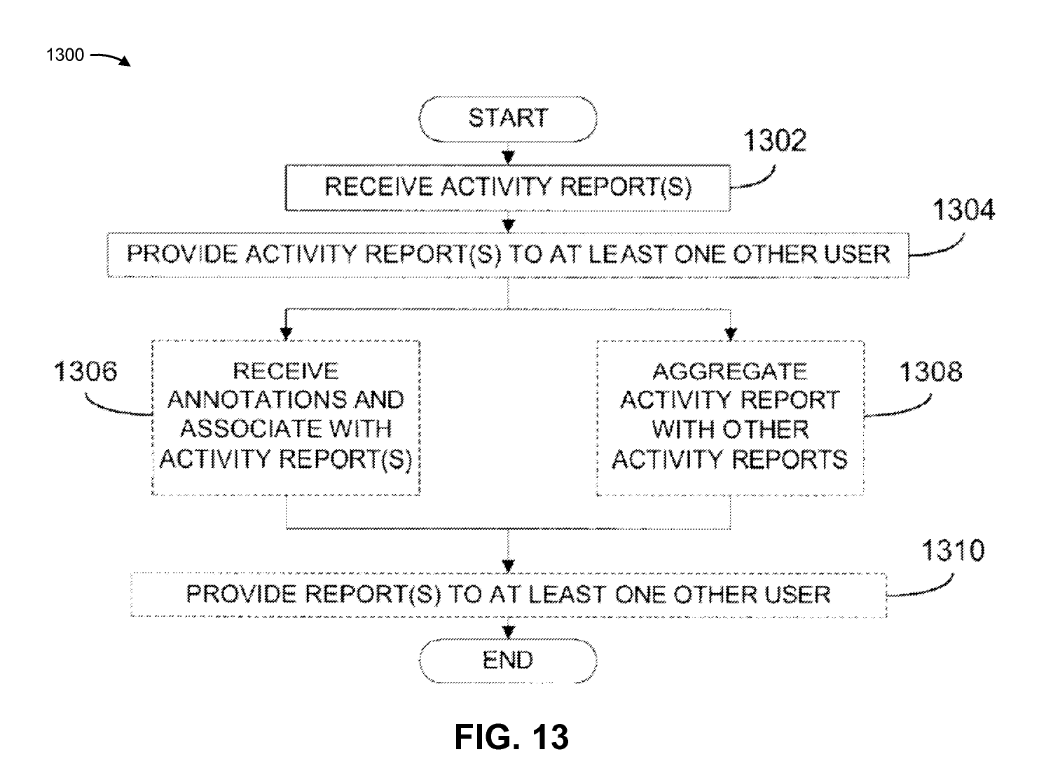

Referring now to FIG. 13, further processing concerning handling of activity reports by a controller is described. As noted above, the operations illustrated in FIG. 13 may be implemented using stored, executable instructions that control operation of one or more suitable processors. Beginning at block 1302, the controller receives one or more activity reports from users via their corresponding user terminals. The communication channels described above for use in sending and receiving messages may be equally employed for this purpose. As noted above, the manner in which the activity reports are received may be in response to polling and/or requests of user terminals made by the controller, or they may be automatically provided to the controller as in a push configuration. Regardless of the manner in which they are received, the reports may be stored by the controller.

Continuing at block 1304, the controller provides the one or more activity reports (using the previously described communication channels) to users of the collaboration system that have been designated to receive them, either by assignment, choice or both. Processing thereafter optionally continues at either or both of blocks 1306 and 1308. At block 1306, one or more annotations may be received by the controller and associated with various ones of the activity reports. Annotations may be received from any of the users of the collaboration system, including the user that is the subject of a given activity report, or any of the targeted recipients of the activity report. To this end, although block 1306 is illustrated as sequentially occurring after block 1304, in practice the annotations received at block 1306 may actually be received (and associated with corresponding activity reports) prior to provision of the activity reports to the designated users. Alternatively, such annotations could be received from a recipient of an activity report after the fact as well. In this manner, the activity reports of individual users may serve as a basis for establishing context around important issues and events. Processing may also proceed at block 1308 where the controller aggregates individual activity reports to provide one or more aggregated activity reports. Any annotations included with the constituent activity reports included in an aggregated activity report may likewise be associated with the aggregated activity report. Thereafter, at block 1308, any aggregated activity reports, or any individual activity reports either not previously sent or being sent with recently associated annotations, may be provided to the designated users at block 1310.

As described above, the present invention provides a collaboration system that organizes communication channels between collaboration team members, builds context around communications between team members and provides tools for better developing relationships between collaborators. This is achieved through the production of activity reports based on the capture of events defined according a project plan. The ability to further associate annotations with such activity reports enhances the establishment of context around important issues. Further still, aggregation of activity reports provides context around entire groups of individuals. In this manner, the present invention overcomes many of the shortcomings found in the prior art.

While the particular preferred embodiments of the present invention have been shown and described, various changes and modifications may be made without departing from the teachings of the invention. For example, activity report generation may be distributed, i.e., the user terminals may provide the stored event information to the controller, which performs activity report generation. It is therefore contemplated that the present invention cover any and all modifications, variations or equivalents that fall within the scope of the basic underlying principles disclosed above and claimed herein.

What is claimed is:

1. A system, comprising:
a user device configured to:
receive a plurality of messages via a plurality of user interface components associated with a user interface,
analyze, based on receiving the plurality of messages, the plurality of messages,
generate a plurality of metadata values based on analyzing the plurality of messages, and
provide the plurality of messages and the plurality of metadata values to a controller device, via the user interface; and
the controller device configured to:
receive the plurality of messages and the plurality of metadata values from the user device, via the user interface,
receive profile information associated with the user device from a database server device,
identify a plurality of recipient user devices for the plurality of messages based on the plurality of metadata values and based on the profile information, and
cause the plurality of messages to be provided to the plurality of recipient user devices.

2. The system of claim 1, where the controller device comprises a proxy server device and an application web server device,
the proxy server device communicating with the user device and being configured to receive the plurality of messages and the plurality of metadata values from the user device, via the user interface;
the application web server device communicating with the proxy server device, the database server device, and an email server device, and being configured to:
receive the profile information from the database server device,
identify the plurality of recipient user devices for the plurality of messages based on the plurality of metadata values and based on the profile information, and
provide the plurality of messages to the email server device.

3. The system of claim 2, where the application web server device communicates with an active directory server device and a software development server device, and the application web server is further configured to:
receive configuration information, for the controller device, from the active directory server device, and
receive software development information, for the controller device, from the software development server device.

4. The system of claim 1, where the user device is further configured to:
associate the plurality of metadata values with the plurality of messages.
